(19) United States
(12) Patent Application Publication
(10) Pub. No.: US 2022/0250443 A1
(43) Pub. Date: Aug. 11, 2022

(54) VEHICLE AND INFECTIOUS DISEASE PREVENTION METHOD

(71) Applicant: TOYOTA JIDOSHA KABUSHIKI KAISHA, Toyota-shi Aichi-ken (JP)

(72) Inventors: Ryota Tomizawa, Susono-shi Shizuoka-ken (JP); Shozo Takaba, Chiryu-shi Aichi-ken (JP); Ayako Shimizu, Nummazu-shi Shizouka-ken (JP); Hojung Jung, Sunto-gun Shizuoka-ken (JP); Daisuke Sato, Toyota-shi Aichi-ken (JP); Yasuhiro Kobatake, Nagoya-shi Aichi-ken (JP)

(21) Appl. No.: 17/546,235

(22) Filed: Dec. 9, 2021

(30) Foreign Application Priority Data
Feb. 8, 2021 (JP) 2021-018071

(51) Int. Cl. B60H 1/24; B60H 1/00

(52) U.S. Cl. CPC B60H 1/247; B60H 1/00371; B60H 1/00742

(57) ABSTRACT

A vehicle includes an airflow generator configured to generate an airflow directed from the upper side to the lower side inside a vehicle cabin of the vehicle. The airflow generator generates the airflow such that the airflow directed from the upper side to the lower side does not hit a passenger inside the vehicle cabin.

### CROSS-REFERENCE TO RELATED APPLICATION

This application claims priority to Japanese Patent Application No. 2021-018071 filed on Feb. 8, 2021, incorporated herein by reference in its entirety.

### BACKGROUND

### 1. Technical Field

The present disclosure relates to a vehicle and an infectious disease prevention method for a vehicle.

### 2. Description of Related Art

Japanese Unexamined Patent Application Publication No. 2004-175268 (JP 2004-175268 A) and Japanese Unexamined Patent Application Publication No. 2004-284443 (JP 2004-284443 A) each describe a vehicle air-conditioning device configured to cause thermos regulated air to flow downward from above passengers inside a vehicle cabin.

### SUMMARY

In the meantime, in order to reduce an infection risk of infection disease due to droplet infection or aerial infection inside the vehicle cabin, it is desirable to restrain diffusion of exhaled breath and droplets of passengers inside a vehicle cabin. In view of this, it is conceivable that the diffusion of exhaled breath and droplets of the passengers is shut off by a mechanism such as an air curtain, for example

However, as described in JP 2004-175268 A or JP 2004-284443 A, when the air directly hits a passenger, the passenger might feel uncomfortable. Further, in a case where the air flows toward the head of a passenger, the flow of exhaled breath and droplets discharged forward from the passenger may not be shut off effectively.

In view of this, an object of the present disclosure is to restrain diffusion of exhaled breath and droplets of passengers inside a vehicle cabin without causing the passengers to feel uncomfortable.

A summary of this disclosure is as follows.

(1) A vehicle according to this disclosure is a vehicle including an airflow generator configured to generate an airflow directed from an upper side to a lower side inside a vehicle cabin of the vehicle. The airflow generator generates the airflow such that the airflow does not hit a passenger inside the vehicle cabin.

(2) In the vehicle described in (1), the airflow generator may be placed such that the airflow passes between seats provided in the vehicle.

(3) The vehicle described in (1) or (2) may further include a passenger detection device and a control device. The passenger detection device may be configured to detect a passenger inside the vehicle cabin. The control device may be configured to control the airflow generator. The control device may specify a position where no passenger is present, based on an output from the passenger detection device, and may activate the airflow generator such that the airflow is generated at the position where no passenger is present.

(4) The vehicle described in any one of (1) to (3) may further include a passenger detection device and a control device. The passenger detection device may be configured to detect a passenger inside the vehicle cabin. The control device may be configured to control the airflow generator. In a case where a passenger is present inside the vehicle cabin, the control device may activate the airflow generator. In a case where no passenger is present inside the vehicle cabin, the control device may not activate the airflow generator.

(5) The vehicle described in any one of (1) to (3) may further include a passenger detection device and a control device. The passenger detection device may be configured to detect a passenger inside the vehicle cabin. The control device may be configured to control the airflow generator. In a case where the number of passengers inside the vehicle cabin is equal to or more than a threshold of two or more, the control device may activate the airflow generator. In a case where the number of passengers inside the vehicle cabin is less than the threshold, the control device may not activate the airflow generator.

(6) An infectious disease prevention method according to this disclosure is an infectious disease prevention method in a vehicle including an airflow generator configured to generate an airflow directed from an upper side to a lower side inside a vehicle cabin. The infectious disease prevention method includes generating, by the airflow generator, the airflow such that the airflow does not hit a passenger inside the vehicle cabin.

With the present disclosure, it is possible to restrain dispersion of exhaled breath and droplets of passengers inside the vehicle cabin without causing the passengers to feel uncomfortable.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view schematically illustrating a vehicle according to a first embodiment of the present disclosure;

FIG. 2 is a view schematically illustrating part of a vehicle cabin of the vehicle in FIG. 1;

FIG. 3 is a view schematically illustrating an exemplary configuration of an air blowing device;

FIG. 4 is a view schematically illustrating an exemplary configuration of an air discharge device;

FIG. 5 is a view illustrating an example of a positional relationship between seats and an airflow generator in a plan view of the vehicle;

FIG. 6 is a view illustrating another example of the positional relationship between the seats and the airflow generator in a plan view of the vehicle;

FIG. 7 is a block diagram illustrating a configuration of a vehicle according to a second embodiment of the present disclosure;

FIG. 8 is a flowchart illustrating a control routine of an airflow generation process according to the second embodiment of the present disclosure;

FIG. 9 is a flowchart illustrating a control routine of an airflow generation process according to a third embodiment of the present disclosure; and

FIG. 10 is a flowchart illustrating a control routine of an airflow generation process according to a fourth embodiment of the present disclosure.

### DETAILED DESCRIPTION OF EMBODIMENTS

With reference to the drawings, the following describes a vehicle and an infectious disease prevention method according to embodiments of the present disclosure. Note that, in the following description, the same constituent components have the same reference sign.

### First Embodiment

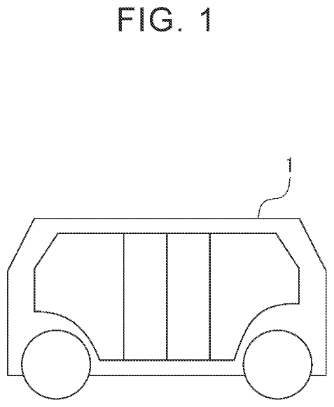

First, with reference to FIGS. 1 to 6, a first embodiment of the present disclosure will be described. FIG. 1 is a view schematically illustrating a vehicle 1 according to the first embodiment of the present disclosure. The vehicle 1 includes a plurality of seats and is configured to transport a plurality of passengers. For example, the vehicle 1 is a shuttle bus the operation route of which is determined in advance.

Further, the vehicle 1 is configured to reduce an infection risk of infection disease to the passengers of the vehicle 1. That is, the vehicle 1 is an infectious disease countermeasures vehicle.

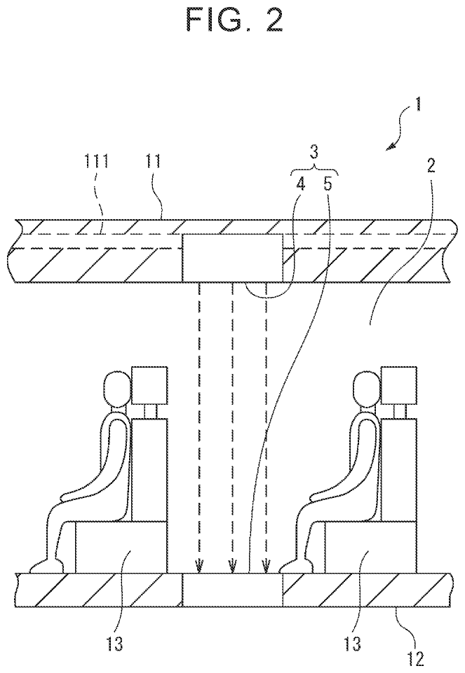

FIG. 2 is a view schematically illustrating part of a vehicle cabin 2 of the vehicle 1 in FIG. 1. As illustrated in FIG. 2, the vehicle 1 includes an airflow generator 3 configured to generate an airflow. The airflow generated by the airflow generator 3 functions as an air curtain and shuts off the flow of exhaled breath and droplets of the passengers inside the vehicle cabin 2. Hereby, it is possible to restrain infection of infectious disease via exhaled breath or droplets of a passenger infected with the infectious disease.

The airflow generator 3 is configured to generate an airflow directed from the upper side to the lower side inside the vehicle cabin 2. In the present embodiment, the airflow generator 3 is a so-called push-pull ventilation apparatus. The airflow generator 3 includes an air blowing device 4 configured to blow air into the vehicle cabin 2, and an air discharge device 5 configured to suck up and discharge the air blown by the air blowing device 4.

The air blowing device 4 is placed in a ceiling 11 of the vehicle 1, and the air discharge device 5 is placed in a floor 12 of the vehicle 1. As a result, as indicated by broken-line arrows in FIG. 2, the airflow generator 3 generates an airflow directed from the ceiling 11 of the vehicle 1 to the floor 12 of the vehicle 1. Further, in the present embodiment, the air blowing device 4 and the air discharge device 5 are placed to face each other in the up-down direction of the vehicle 1.

As illustrated in FIG. 2, an air intake duct 111 is formed in the ceiling 11 of the vehicle 1. The air intake duct 111 communicates with outside the vehicle 1 via an air intake port opened outside the vehicle 1. The air blowing device 4 is connected to the air intake duct 111 and takes in air outside the vehicle 1 through the air intake duct 111. Note that the air taken into the air blowing device 4 via the air intake duct 111 may be air at room temperature or may be air thermos regulated by an air-conditioning device or the like. Further, the air intake duct 111 may be configured to communicate with the vehicle cabin 2. In this case, the air blowing device 4 takes in air inside the vehicle cabin 2 through the air intake duct 111. Further, the air intake duct 111 may be configured to selectively communicate with outside the vehicle 1 or the vehicle cabin 2.

The air blowing device 4 is configured to generate an airflow having high straightness, that is, an airflow having low diffusivity. Accordingly, the air blown by the air blowing device 4 goes straight toward a predetermined direction. For example, the air blowing device 4 is configured as a push hood configured to blow an airflow uniform in the same direction.

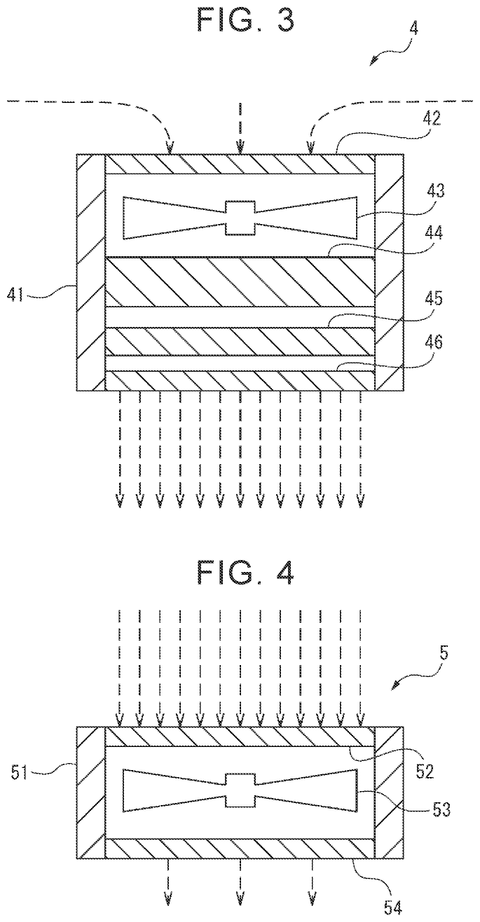

FIG. 3 is a view schematically illustrating an exemplary configuration of the air blowing device 4. As illustrated in FIG. 3, the air blowing device 4 includes a housing 41, an air inflow portion 42, an air sending blower 43, a filter 44, a flow adjusting portion 45, and a blow-out portion 46. In the housing 41, the air inflow portion 42, the air sending blower 43, the filter 44, the flow adjusting portion 45, and the blow-out portion 46 are accommodated in this order along the direction of the flow of the air.

The air inflow portion 42 is placed in the uppermost stream side of the air blowing device 4 and communicates with the air intake duct 111. Accordingly, the air flows into the air blowing device 4 through the air inflow portion 42. For example, the air inflow portion 42 is constituted by a plate having a plurality of holes opened inside the air intake duct 111. Note that the air blowing device 4 may be configured such that the air inflow portion 42 directly communicates with outside the vehicle 1.

The air sending blower 43 is placed in the downstream side of the air inflow portion 42 and sucks the air into the air blowing device 4 through the air inflow portion 42. For example, the air sending blower 43 is constituted by a fan including rotating blades. The air sending blower 43 operates by electric power and supplies the air taken into the air blowing device 4 to the blow-out portion 46 via the filter 44 and the flow adjusting portion 45.

The filter 44 is placed between the air sending blower 43 and the flow adjusting portion 45 and collects impurities in the air. That is, the filter 44 clears the air taken into the air blowing device 4. For example, the filter 44 is constituted by a high efficiency filter such as a high efficiency particulate air filter (HEPA), an ultra-low penetration air filter (ULPA), or the like.

The flow adjusting portion 45 is placed between the filter 44 and the blow-out portion 46 and adjusts the airflow such that the airflow becomes uniform. That is, the flow adjusting portion 45 adjusts the airflow generated by the operation of the air sending blower 43 such that the speed and the direction of the airflow become uniform. The flow adjusting portion 45 has a well-known structure and is constituted by a punching plate, a net member, or the like, for example.

The blow-out portion 46 is placed in the lowermost stream side of the air blowing device 4 and communicates with an upper part of the vehicle cabin 2. Accordingly, the air supplied by the air sending blower 43 is blown into the vehicle cabin 2 from the blow-out portion 46. For example, the blow-out portion 46 is constituted by a plate having a plurality of holes opened inside the vehicle cabin 2.

The flow adjusting portion 45 and the blow-out portion 46 are configured such that uniform air is blown downward. Accordingly, when the air sending blower 43 is activated, the air blowing device 4 can generate an airflow directed from the ceiling 11 of the vehicle 1 to the floor 12 of the vehicle 1.

Note that a prefilter having collecting performance lower than that of the filter 44 may be provided between the air inflow portion 42 and the air sending blower 43. Further, the filter 44 may be omitted in a case where the air outside the vehicle 1 is taken into the air blowing device 4.

FIG. 4 is a view schematically illustrating an exemplary configuration of the air discharge device 5. The air discharge device 5 is provided as a pull hood configured to suck the uniform air blown by the air blowing device 4, for example. As illustrated in FIG. 4, the air discharge device 5 includes a housing 51, an air inflow portion 52, an air discharge blower 53, and an air outlet portion 54. In the housing 51, the air inflow portion 52, the air discharge blower 53, and the air outlet portion 54 are accommodated in this order along the direction of the flow of the air.

The air inflow portion 52 is placed in the uppermost stream side of the air discharge device 5 and communicates with a lower part of the vehicle cabin 2. Accordingly, the air flows into the air discharge device 5 through the air inflow portion 52. For example, the air inflow portion 52 is constituted by a plate having a plurality of holes opened inside the vehicle cabin 2.

The air discharge blower 53 is placed in the downstream side of the air inflow portion 52 and sucks the air into the air discharge device 5 through the air inflow portion 52. For example, the air discharge blower 53 is constituted by a fan including rotating blades. The air discharge blower 53 operates by electric power and supplies the air taken into the air discharge device 5 to the air outlet portion 54.

The air outlet portion 54 is placed in the lowermost stream side of the air discharge device 5 and communicates with outside the vehicle 1. Accordingly, the air supplied by the air discharge blower 53 is discharged to outside the vehicle 1 through the air outlet portion 54. For example, the air outlet portion 54 is constituted by a plate having a plurality of holes opened outside the vehicle 1.

The air discharge device 5 can assist the generation of the airflow directed from the upper side to the lower side by sucking the air by the air discharge blower 53. This accordingly makes it possible to restrain impurity collecting performance by the airflow from decreasing as the airflow is distanced from the air blowing device 4. Further, it is possible to reduce a driving force necessary for the air sending blower 43 to generate the airflow from the upper side to the lower side.

Note that an air discharge duct communicating with outside the vehicle 1 via an air discharge port opened outside the vehicle 1 may be formed in the floor 12 of the vehicle 1 such that the air discharge device 5 may be connected to the air discharge duct. In this case, the air outlet portion 54 communicates with the air discharge duct, and the air discharge device 5 discharges the air to outside the vehicle 1 through the air discharge duct. Further, a filter like the filter 44 may be provided between the air discharge blower 53 and the air outlet portion 54.

The airflow generator 3 is activated when an ignition switch of the vehicle 1 is turned on, for example. In the airflow generator 3, when the air blown by the air blowing device 4 passes through the vehicle cabin 2, the air thus blown collects impurities in the air inside the vehicle cabin 2, and the impurities thus collected is discharged outside the vehicle 1 by the air discharge device 5. Thus, the airflow generated by the airflow generator 3 can restrain dispersion of exhaled breath and droplets of the passengers inside the vehicle cabin 2.

However, when the air generated by the airflow generator 3 directly hits a passenger, the passenger might feel uncomfortable. Further, in a case where the air flows toward the head of a passenger, the flow of exhaled breath and droplets discharged forward from the passenger may not be shut off effectively.

In view of this, in the present embodiment, the airflow generator 3 generates the airflow such that the airflow directed from the upper side to the lower side does not hit the passengers inside the vehicle cabin 2. With this configuration, it is possible to restrain dispersion of exhaled breath and droplets of the passengers inside the vehicle cabin 2 without causing the passengers to feel uncomfortable.

For example, as illustrated in FIG. 2, the airflow generator 3 is placed such that the airflow directed from the upper side to the lower side passes between seats 13 provided in the vehicle 1. More specifically, the airflow generator 3, i.e., the air blowing device 4 and the air discharge device 5 are placed between the seats 13 in a plan view of the vehicle 1. Note that the plan view of the vehicle 1 indicates a state where the vehicle 1 is viewed from the upper side to the lower side.

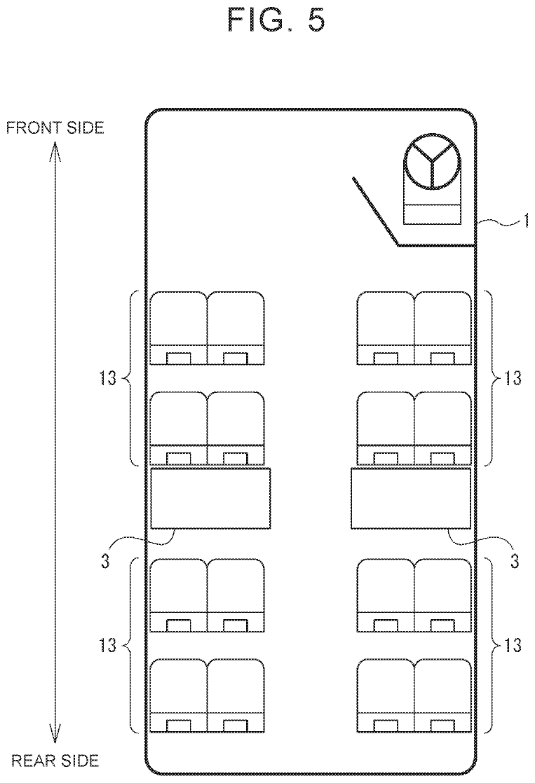

FIG. 5 is a view illustrating an example of a positional relationship between the seats 13 and the airflow generator 3 in a plan view of the vehicle 1. In the example of FIG. 5, the vehicle 1 is provided with four rows of the seats 13 in the front-rear direction, and two airflow generators 3 are placed in a space provided between the seats 13 in two front rows and the seats 13 in two rear rows. The two airflow generators 3 each extend in the right-left direction of the vehicle 1 and shut off the flow of exhaled breath and droplets of the passengers in the front-rear direction of the vehicle 1.

Note that one airflow generator 3 may be placed to cross the vehicle 1 between the seats 13 in the two front rows and the seats 13 in the two rear rows. Further, the airflow generator 3 may be placed between the seats 13 in the two front rows, and the airflow generator 3 may be placed between the seats 13 in the two rear rows. Further, the airflow generator 3 may be placed to extend in the front-rear direction of the vehicle 1 between the seats 13 on the left side and the seats 13 on the right side such that the flow of exhaled breath and droplets of the passengers in the right-left direction of the vehicle 1 is shut off.

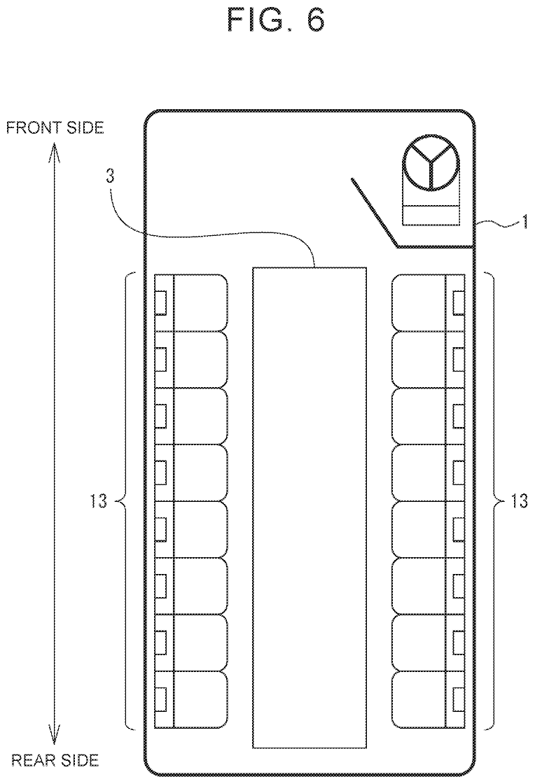

FIG. 6 is a view illustrating another example of the positional relationship between the seats 13 and the airflow generator 3 in a plan view of the vehicle 1. In the example of FIG. 6, in the vehicle 1, the seats 13 on the right side and the seats 13 on the left side are placed to face each other, and the airflow generator 3 is placed in a space provided between the seats 13 on the right side and the seats 13 on the left side. The airflow generator 3 extends in the front-rear direction of the vehicle 1 and shuts off the flow of exhaled breath and droplets of the passengers in the right-left direction of the vehicle 1. Note that a plurality of airflow generators 3 may be placed at intervals in the front-rear direction of the vehicle 1.

### Second Embodiment

A vehicle according to a second embodiment has a configuration basically similar to the configuration of the vehicle according to the first embodiment except the following points. On this account, the following describes the second embodiment of the present disclosure mainly about points different from the first embodiment.

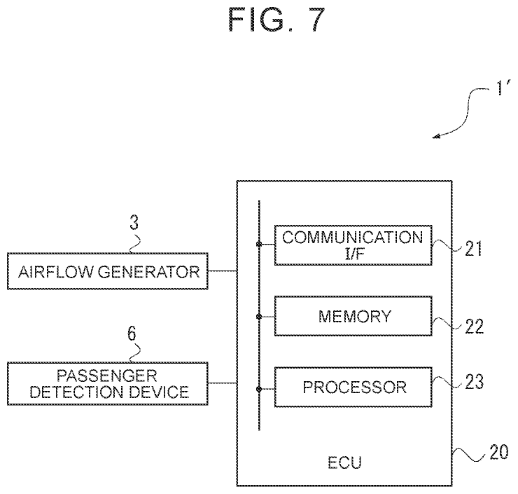

FIG. 7 is a block diagram illustrating a configuration of a vehicle 1′ according to the second embodiment of the present disclosure. As illustrated in FIG. 7, the vehicle 1′ includes an electronic control unit (ECU) 20. The ECU 20 includes a communication interface 21, a memory 22, and a processor 23 and executes various controls on the vehicle 1′. The communication interface 21 and the memory 22 are connected to the processor 23 via a signal wire. The ECU 20 is one example of a control device of the vehicle 1′, the control device being provided in the vehicle 1′. Note that, in the present embodiment, one ECU 20 is provided, but a plurality of ECUS may be provided for respective functions.

The communication interface 21 has an interface circuit via which the ECU 20 is connected to an in-vehicle network in conformity with a standard such as a controller area network (CAN). The ECU 20 communicates with in-vehicle devices connected to the in-vehicle network via the communication interface 21 and the in-vehicle network.

The memory 22 includes, for example, a volatile semiconductor memory (e.g., a RAM) and a nonvolatile semiconductor memory (e.g., a ROM). In the memory 22, computer programs to be executed by the processor 23, various pieces of data to be used when various processes are executed by the processor 23, and so on are stored. Note that the computer programs to be executed by the processor 23 may be provided such that the computer programs are stored in a computer readable recording medium. The computer readable recording medium is, for example, a magnetic recording medium, an optical recording medium, or a semiconductor memory.

The processor 23 includes one or more central processing units (CPU) and a peripheral circuit thereof and executes various processes. Note that the processor 23 may further include other computing circuits such as a logic-arithmetic unit, a mathematical operation unit, or a graphics processing unit.

Further, as illustrated in FIG. 2, the vehicle 1′ includes the airflow generator 3 and a passenger detection device 6. The airflow generator 3 and the passenger detection device 6 are each electrically connected to the ECU 20.

The airflow generator 3 has the configuration described above and is configured to generate an airflow directed from the upper side to the lower side inside the vehicle cabin 2. The ECU 20 controls the airflow generator 3. More specifically, the ECU 20 controls respective operational states of the air sending blower 43 and the air discharge blower 53 of the airflow generator 3 and controls generation or non-generation of the airflow by the airflow generator 3.

The passenger detection device 6 detects a passenger inside the vehicle cabin 2. For example, the passenger detection device 6 is constituted by a motion sensor such as an infrared sensor configured to detect infrared radiation emitted from people. The output of the passenger detection device 6 is sent to the ECU 20, and the ECU 20 determines whether there is a passenger or not, based on the output from the passenger detection device 6. Note that, in the present specification, the passenger in the vehicle cabin indicates an occupant in the vehicle other than a driver of the vehicle.

In the meantime, in a case where passengers are allowed to ride in the vehicle 1′ in a standing manner, a passenger may be present at a position other than the seats 13. Accordingly, even when the airflow directed from the upper side to the lower side is generated at the position other than the seats 13, the airflow may hit the passenger.

In view of this, the passenger detection device 6 is placed inside the vehicle 1′ so as to detect a passenger placed in an airflow generation range where the airflow is generated by the airflow generator 3. For example, the passenger detection device 6 is placed in a bottom portion of the air blowing device 4 or in the vicinity of the air blowing device 4.

The ECU 20 specifies a position where no passenger is present, based on the output from the passenger detection device 6, and activates the airflow generator 3 such that the airflow is generated at the position where no passenger is present. For example, a plurality of airflow generators 3 is placed in the vehicle 1′, and among the airflow generators 3, the ECU 20 activates an airflow generator 3 having an airflow generation range in which no passenger is present, and the ECU 20 does not activate an airflow generator 3 having an airflow generation range in which a passenger is present. Hereby, it is possible to restrain dispersion of exhaled breath and droplets of passengers in the vehicle 1′ without causing the passengers to feel uncomfortable.

Note that the passenger detection device 6 may be an in-vehicle camera configured to capture the vehicle cabin 2 and form an image inside the vehicle cabin 2. In this case, the ECU 20 specifies a position where no passenger is present, based on the output from the passenger detection device 6 by use of a well-known image recognition technology such as a machine learning.

Further, in the second embodiment, the airflow generator 3 may be placed at the same position as the seat 13 in a plan view of the vehicle 1, and only when no passenger sits on the seat 13, the ECU 20 may activate the airflow generator 3. In this case, for example, the airflow generator 3 is provided for each seat 13 such that the air discharge device 5 of the airflow generator 3 is placed in a space under a seating face of the each seat 13. Note that, in this case, the passenger detection device 6 may be a seat sensor configured to detect whether a passenger sits on the seat or not.

Further, the air blowing device 4 may be provided with a shutter configured to open and close the blow-out portion 46 of the air blowing device 4, and the ECU 20 may change the airflow generation range by the shutter so that the airflow is generated at a position where no passenger is present.

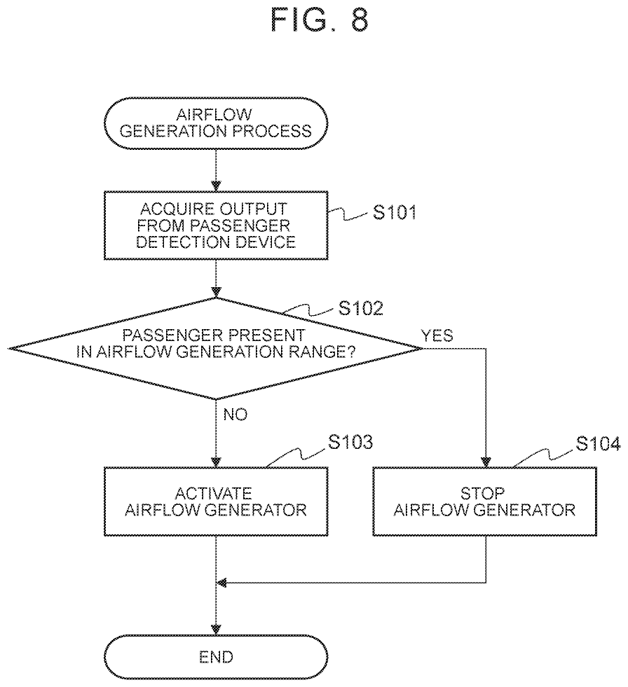

The following describes the aforementioned control with reference to a flowchart of FIG. 8. FIG. 8 is a flowchart illustrating a control routine of an airflow generation process according to the second embodiment of the present disclosure. This control routine is executed by the ECU 20 repeatedly at every predetermined execution interval on each of the airflow generators 3.

First, in step S101, the ECU 20 acquires an output from the passenger detection device 6 configured to detect a passenger placed in the airflow generation range of the airflow generator 3. Subsequently, in step S102, the ECU 20 determines, based on the output from the passenger detection device 6, whether or not a passenger is present in the airflow generation range of the airflow generator 3.

In a case where the ECU 20 determines in step S102 that no passenger is present in the airflow generation range, the control routine proceeds to step S103. In step S103, the ECU 20 activates the airflow generator 3. More specifically, the ECU 20 supplies electric power to the air sending blower 43 of the air blowing device 4 and the air discharge blower 53 of the air discharge device 5 so as to activate the air sending blower 43 and the air discharge blower 53. As a result, the airflow in the up-down direction is generated by the airflow generator 3. After step S103, this control routine is ended.

In the meantime, in a case where the ECU 20 determines in step S102 that a passenger is present in the airflow generation range, this control routine proceeds to step S104. In step S104, the ECU 20 stops the airflow generator 3. In other words, the ECU 20 does not activate the airflow generator 3. More specifically, the ECU 20 stops supply of electric power to the air sending blower 43 of the air blowing device 4 and the air discharge blower 53 of the air discharge device 5 so as to stop the air sending blower 43 and the air discharge blower 53. After step S104, this control routine is ended.

### Third Embodiment

A vehicle according to a third embodiment has a configuration basically similar to the configuration of the vehicle according to the first embodiment except the following points. On this account, the following describes the third embodiment of the present disclosure mainly about points different from the first embodiment.

Similarly to the second embodiment, in the third embodiment, the vehicle 1′ includes the airflow generator 3, the passenger detection device 6, and the ECU 20. In the third embodiment, the ECU 20 determines, based on an output from the passenger detection device 6 such as an in-vehicle camera, whether or not a passenger is present inside the vehicle cabin 2.

In a case where no passenger is present inside the vehicle cabin 2, exhaled breath and droplets of the passenger are not generated inside the vehicle cabin 2. Accordingly, in the third embodiment, in a case where a passenger is present inside the vehicle cabin 2, the ECU 20 activates the airflow generator 3, and in a case where no passenger is present inside the vehicle cabin 2, the ECU 20 does not activate the airflow generator 3. Hereby, it is possible to restrain dispersion of exhaled breath and droplets of passengers and to reduce power consumption caused by the operation of the airflow generator 3.

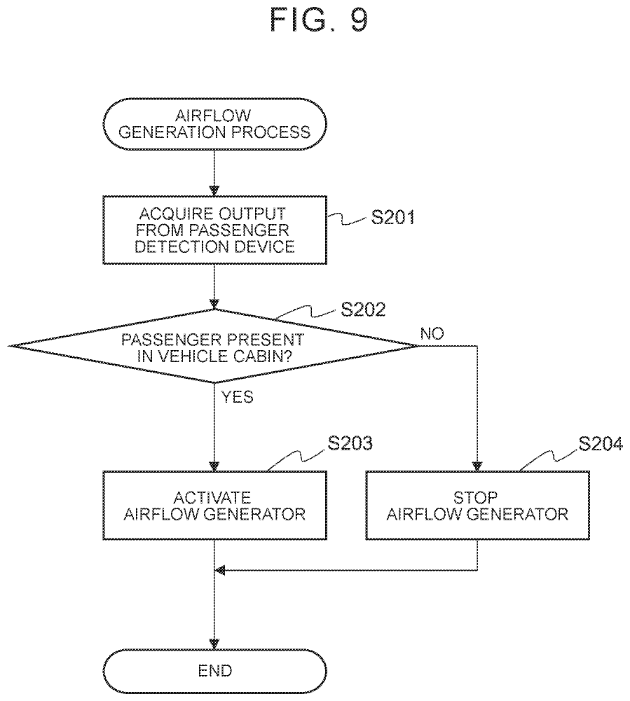

The following describes the aforementioned control with reference to a flowchart of FIG. 9. FIG. 9 is a flowchart illustrating a control routine of an airflow generation process according to a third embodiment of the present disclosure. This control routine is executed by the ECU 20 repeatedly at every predetermined interval.

First, in step S201, the ECU 20 acquires an output from the passenger detection device 6. Subsequently, in step S202, the ECU 20 determines, based on the output from the passenger detection device 6, whether or not a passenger is present inside the vehicle cabin 2.

In a case where the ECU 20 determines in step S202 that a passenger is present inside the vehicle cabin 2, this control routine proceeds to step S203. In step S203, the ECU 20 activates the airflow generator 3. More specifically, the ECU 20 supplies electric power to the air sending blower 43 of the air blowing device 4 and the air discharge blower 53 of the air discharge device 5 so as to activate the air sending blower 43 and the air discharge blower 53. As a result, the airflow in the up-down direction is generated by the airflow generator 3. After step S203, this control routine is ended.

In the meantime, in a case where the ECU 20 determines in step S202 that no passenger is present inside the vehicle cabin 2, this control routine proceeds to step S204. In step S204, the ECU 20 stops the airflow generator 3. In other words, the ECU 20 does not activate the airflow generator 3. More specifically, the ECU 20 stops supply of electric power to the air sending blower 43 of the air blowing device 4 and the air discharge blower 53 of the air discharge device 5 so as to stop the air sending blower 43 and the air discharge blower 53. After step S204, this control routine is ended.

### Fourth Embodiment

A vehicle according to a fourth embodiment has a configuration basically similar to the configuration of the vehicle according to the first embodiment except the following points. On this account, the following describes the fourth embodiment of the present disclosure mainly about points different from the first embodiment.

Similarly to the second embodiment, in the fourth embodiment, the vehicle 1′ includes the airflow generator 3, the passenger detection device 6, and the ECU 20. In the fourth embodiment, the ECU 20 detects the number of passengers inside the vehicle cabin 2 based on an output from the passenger detection device 6 such as an in-vehicle camera.

In a case where the number of passengers inside the vehicle cabin 2 is small, the infection risk of infection disease due to exhaled breath or droplets of the passengers is low in comparison with a case where the number of passengers inside the vehicle cabin 2 is large. Accordingly, in the fourth embodiment, in a case where the number of passengers inside the vehicle cabin 2 is equal to or more than a threshold of two or more, the ECU 20 activates the airflow generator 3, and in a case where the number of passengers inside the vehicle cabin 2 is less than the threshold, the ECU 20 does not activate the airflow generator 3. Hereby, it is possible to reduce the infection risk of infection disease, and it is also possible to reduce power consumption caused by the operation of the airflow generator 3.

Particularly, in a case where the number of passengers inside the vehicle cabin 2 is one, exhaled breath and droplets of the passenger do not directly hit other passengers, so that the necessity to restrain diffusion of the exhaled breath and droplets of the passenger is low. In some embodiments, on this account, the threshold is set to two.

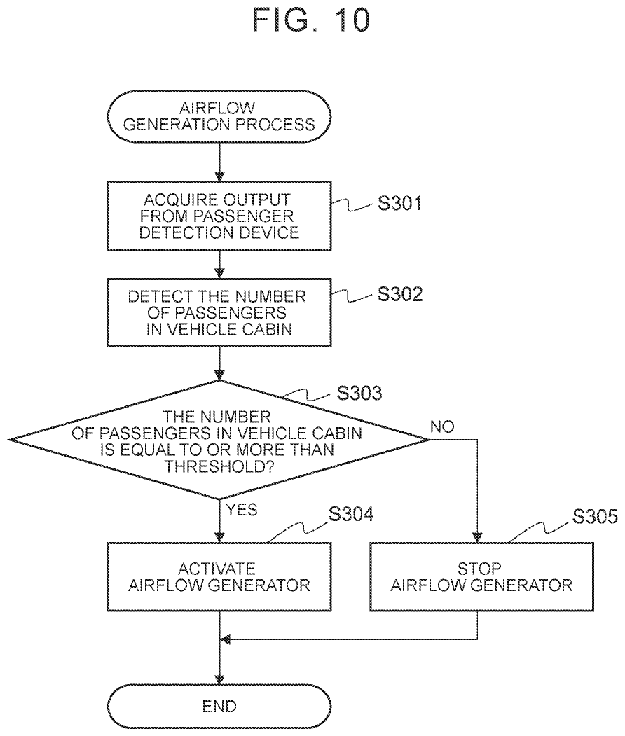

The following describes the aforementioned control with reference to a flowchart of FIG. 10. FIG. 10 is a flowchart illustrating a control routine of an airflow generation process according to the fourth embodiment of the present disclosure. This control routine is executed by the ECU 20 repeatedly at every predetermined execution interval.

First, in step S301, the ECU 20 acquires an output from the passenger detection device 6. Subsequently, in step S302, the ECU 20 detects the number of passengers inside the vehicle cabin 2 based on the output from the passenger detection device 6.

Subsequently, in step S303, the ECU 20 determines whether or not the number of passengers inside the vehicle cabin 2 is equal to or more than the threshold. The threshold is determined in advance and is set to an integer of two or more, or set to two.

In a case where the ECU 20 determines in step S303 that the number of passengers in the vehicle cabin 2 is the threshold or more, this control routine proceeds to step S304. In step S304, the ECU 20 activates the airflow generator 3. More specifically, the ECU 20 supplies electric power to the air sending blower 43 of the air blowing device 4 and the air discharge blower 53 of the air discharge device 5 so as to activate the air sending blower 43 and the air discharge blower 53. As a result, the airflow in the up-down direction is generated by the airflow generator 3. After step S304, this control routine is ended.

In the meantime, in a case where the ECU 20 determines in step S303 that the number of passengers inside the vehicle cabin 2 is less than the threshold, this control routine proceeds to step S305. In step S305, the ECU 20 stops the airflow generator 3. In other words, the ECU 20 does not activate the airflow generator 3. More specifically, the ECU 20 stops supply of electric power to the air sending blower 43 of the air blowing device 4 and the air discharge blower 53 of the air discharge device 5 so as to stop the air sending blower 43 and the air discharge blower 53. After step S305, this control routine is ended.

### Other Embodiments

Embodiments of the present disclosure have been described above, but the present disclosure is not limited to those embodiments and can be altered and modified variously within the scope of Claims. For example, the vehicle 1, 1′ may be a sightseeing bus, a taxi, or the like. Further, the vehicle 1, 1′ may be a self-driving vehicle configured such that acceleration, steering, and deceleration (braking) of the vehicle 1, 1′ are all controlled automatically. That is, no driver may be present in the vehicle 1, 1′.

Further, the airflow generator 3 may include an air discharge port via which the lower part of the vehicle cabin 2 communicates with outside the vehicle 1, 1′ or the air discharge duct, instead of the air discharge device 5. In this case, the air blown by the air blowing device 4 hits the floor 12 of the vehicle 1, 1′, and after that, the air is discharged through the air discharge port provided in a side portion or the like of the vehicle 1, 1′. Accordingly, even in this case, the airflow can be generated by the airflow generator 3 such that the airflow is directed from the upper side to the lower side inside the vehicle cabin 2.

Further, the airflow generator 3 may include an air blowing port via which the upper part of the vehicle cabin 2 communicates with the air intake duct 111 or outside the vehicle 1, 1′, instead of the air blowing device 4. In this case, a travel wind caused during traveling of the vehicle 1, 1′ is blown into the vehicle cabin 2 through the air blowing port and is sucked by the air discharge device 5. Accordingly, even in this case, the airflow can be generated by the airflow generator 3 such that the airflow is directed from the upper side to the lower side inside the vehicle cabin 2.

Further, the air blowing device 4 may include a disinfectant spraying portion configured to spray disinfectant and may be configured to blow air including the disinfectant into the vehicle cabin 2. Further, the air blowing device 4 may include an anion generation portion configured to generate anions and may be configured to blow air including the anions into the vehicle cabin 2. In those cases, it is possible to further improve a cleaning effect by the airflow generated by the airflow generator 3 such that the airflow is directed from the upper side to the lower side.

Further, the above embodiments can be combined in a given manner. For example, in a case where the second embodiment and the third embodiment are combined with each other, whether the airflow generator 3 is to be activated or not is determined by the control routine in FIG. 8 only when it is determined in step S202 in FIG. 9 that a passenger is present in the vehicle cabin 2. Further, in a case where the second embodiment and the fourth embodiment are combined with each other, whether the airflow generator 3 is to be activated or not is determined by the control routine in FIG. 8 only when it is determined in step S303 in FIG. 10 that the number of passengers inside the vehicle cabin 2 is the threshold or more.

What is claimed is:

1. A vehicle comprising an airflow generator configured to generate an airflow directed from an upper side to a lower side inside a vehicle cabin of the vehicle, wherein the airflow generator generates the airflow such that the airflow does not hit a passenger inside the vehicle cabin.

2. The vehicle according to claim 1, wherein the airflow generator is placed such that the airflow passes between seats provided in the vehicle.

3. The vehicle according to claim 1, further comprising:
a passenger detection device configured to detect a passenger inside the vehicle cabin; and
a control device configured to control the airflow generator, wherein the control device specifies a position where no passenger is present, based on an output from the passenger detection device, and activates the airflow generator such that the airflow is generated at the position where no passenger is present.

4. The vehicle according to claim 1, further comprising:
a passenger detection device configured to detect a passenger inside the vehicle cabin; and
a control device configured to control the airflow generator, wherein:
in a case where a passenger is present inside the vehicle cabin, the control device activates the airflow generator; and
in a case where no passenger is present inside the vehicle cabin, the control device does not activate the airflow generator.

5. The vehicle according to claim 1, further comprising:
a passenger detection device configured to detect a passenger inside the vehicle cabin; and
a control device configured to control the airflow generator, wherein:
in a case where the number of passengers inside the vehicle cabin is equal to or more than a threshold of two or more, the control device activates the airflow generator; and
in a case where the number of passengers inside the vehicle cabin is less than the threshold, the control device does not activate the airflow generator.

6. An infectious disease prevention method in a vehicle including an airflow generator configured to generate an airflow directed from an upper side to a lower side inside a vehicle cabin, the infectious disease prevention method comprising generating, by the airflow generator, the airflow such that the airflow does not hit a passenger inside the vehicle cabin.
